(19) United States
(12) Patent Application Publication
(10) Pub. No.: US 2012/0306262 A1
(43) Pub. Date: Dec. 6, 2012

(54) SHIELD DEVICE FOR RESONANCE TYPE CONTACTLESS POWER TRANSMISSION SYSTEM

(75) Inventor: Yuichi Taguchi, Kariya-shi (JP)

(73) Assignee: KABUSHIKI KAISHA TOYOTA JIDOSHOKKI, Kariya-shi (JP)

(21) Appl. No.: 13/480,939

(22) Filed: May 25, 2012

(30) Foreign Application Priority Data
May 30, 2011 (JP) 2011-120585

(51) Int. Cl. H02J 17/00; B60L 1/00

(52) U.S. Cl. 307/9.1; 307/104

(57) ABSTRACT

A shield device for a resonance type contactless power transmission system that reduces adverse influence on power transmission efficiency without unnecessarily increasing space for installing the shield device is provided. A shield device of the resonance type contactless power transmission system includes cylindrical shield members, which are provided in a power supply unit and a power receiving unit, respectively. The distance between the bottom of the shield member provided in the power supply unit and the primary-side resonance coil and the distance between the bottom of the shield member provided in the power receiving unit and the secondary-side resonance coil are both set to be greater than a distance between the primary-side resonance coil and the secondary-side resonance coil that allows power transmission at the maximum efficiency from the power supply unit to the power receiving unit.

### CROSS REFERENCE TO RELATED APPLICATIONS

This application claims priority to Japanese Application No. 2011-120585 filed May 30, 2011.

### TECHNICAL FIELD

The present invention relates to a shield device for a resonance type contactless power transmission system.

### BACKGROUND

Conventionally, as disclosed in Japanese Laid-Open Patent Publication No. 2010-252498, a wireless power transmission apparatus has been known that includes an intrusion detecting means for appropriately dealing with intrusion of an object into the space between electric power transmission units (between a power delivering unit and a power receiving unit) in the wireless power transmission technology that uses magnetic resonance. According to the Patent Document, in a case where the power receiving unit is mounted on a vehicle, magnetism created during power transmission reaches magnetic bodies (iron plates) such as the chassis and body of the vehicle, which are present on the back side of the power receiving unit. This generates eddy currents in the magnetic bodies. Energy loss caused by the eddy currents lowers the efficiency of electric power transmission (transmission efficiency). The Patent Document discloses a method for limiting such reduction in the transmission efficiency. Specifically, a magnetic shield sheet is arranged on the back of each of the transmitting coil, which performs wireless power transmission, and the receiving coil.

That is, according to the Patent Document, to limit reduction in the transmission efficiency due to generation of eddy currents in magnetic bodies (iron plates) such as the chassis and body of a vehicle, a magnetic shield sheet is provided on the back of each of the transmitting coil and the receiving coil. The purpose of a typical shield member is to suppress radiation noise, which adversely influences, for example, external electronic devices. However, the purpose of the magnetic shield sheet of the Patent Document is different from that of a typical shield member. Further, the Patent Document does not disclose the relationship between the distance from the transmitting coil to the receiving coil and the distance from the magnetic shield sheet to the transmitting coil and to the receiving coil.

Generally, a shield member needs to cover not only the back but also the sides of a coil. Also, if the purpose of a shield member is to suppress radiation noise only, reduction in the distance from the shield member to the coils is sufficient for reducing the space required for installing the shield member. However, the shorter the distance between the shield member and the coils, the greater the reduction in power transmission efficiency of magnetic field resonance. That is, there is a trade-off between reduction in space for installing a shield member and reduction in adverse influence on power transmission efficiency.

The present disclosure has been made in view of the aforementioned problems. It is an objective of the present disclosure to provide a shield device for a resonance type contactless power transmission system that reduces adverse influence on power transmission efficiency without unnecessarily increasing space for installing the shield device.

### SUMMARY

To achieve the foregoing objective and in accordance with one aspect of the present disclosure, a shield device for a resonance type contactless power transmission system is provided. The power transmission system includes a power supply unit having a primary-side resonance coil and a power receiving unit having a secondary-side resonance coil. The secondary-side resonance coil receives power from the primary-side resonance coil through magnetic field resonance. The shield device includes bottom cylindrical shield members, which are provided in the power supply unit and the power receiving unit. The distance between at least a bottom of the shield member provided in the power supply unit and the primary-side resonance coil and the distance between at least a bottom of the shield member provided in the power receiving unit and the secondary-side resonance coil are both set to be greater than a distance between the primary-side resonance coil and the secondary-side resonance coil that allows power transmission at the maximum efficiency from the power supply unit to the power receiving unit.

Connection of magnetic fields occurs not only between resonance coils, but also between an induction coil and a resonance coil and between a resonance coil and a shield member. The mutual inductances between the resonance coils, between the induction coil and the resonance coil, and between the resonance coil and the shield member are denoted by M1, M2, and M3, respectively. Leakage induction of the resonance coil is denoted by LE1. In this case, the self-inductance L of the resonance coil is expressed by the following equation:

L=LE1+M1+M2+M3

This equation indicates that the sum of the mutual inductances M1, M2, M3 and the leakage inductance LE1 is constant and that the mutual inductance M1 between the resonance coils can be increased, that is, magnetic field connection between the resonance coils can be reinforced by reducing the mutual inductances M2, M3 between the resonance coil and the shield member. The stronger the magnetic field connection, the higher the power transmission efficiency between the resonance coils becomes. It is expected that, utilizing these properties, the magnetic field connection between the resonance coils will be increased by weakening the magnetic field connection between the resonance coil and shield member to increase the power transmission efficiency. It was found that, in this case, the power transmission efficiency when the distance between the resonance coil and the shield member was greater than the distance between the resonance coils was greater than the power transmission efficiency when the distance between the resonance coil and the shield member was smaller. Based on the finding, the inventors achieved the subject matter of the present disclosure.

According to this configuration, the distance between the bottom of the cylindrical shield member and the resonance coil is greater than the distance between resonance coils that allows power transmission at the maximum efficiency from the power supply unit to the power receiving unit. Therefore, in a state where power transmission is being performed at maximum efficiency, the magnetic connection between the resonance coils is stronger when the distance between the bottom of the shield member and the resonance coil is greater than the distance between the resonance coils than when the distance between the bottom of the shield member and the resonance coils is less than or equal to the distance between the distance between the resonance coils. Thus, adverse influence on the power transmission efficiency can be reduced without unnecessarily increasing the space for installing the shield device.

In accordance with one aspect, the distance between a cylindrical portion of the shield member provided in the power supply unit and the primary-side resonance coil and the distance between a cylindrical portion of the shield member provided in the power receiving unit and the secondary-side resonance coil are both set to be greater than a distance between the primary-side resonance coil and the secondary-side resonance coil that allows power transmission at the maximum efficiency from the power supply unit to the power receiving unit.

Therefore, according to the configuration, the adverse influence on the power transmission efficiency can be reduced.

In accordance with one aspect, the power receiving unit is mounted on a movable body. The movable body refers, for example, to a vehicle or a robot that is capable of moving on its own. This configuration minimizes the space for installing the shield device, and is favorably applied to a case where the power receiving unit is installed in a vehicle.

In accordance with one aspect, the secondary-side resonance coil and the shield member of the power receiving unit are fixed to the power receiving unit. In a case where the power receiving unit is mounted on a movable body such as a vehicle or a robot, if the positions of the secondary-side resonance coil and the shield member are movable relative to the movable body, the space required for installing the secondary-side resonance coil and the shield member is increased. However, according to the present configuration, since the secondary-side resonance coil and the shield member of the power receiving unit are fixed to the power receiving unit, the space for installing the secondary-side resonance coil and the shield member is easily secured.

### BRIEF DESCRIPTION OF THE DRAWINGS

The features of the present invention that are believed to be novel are set forth with particularity in the appended claims. The invention, together with objects and advantages thereof, may best be understood by reference to the following description of the presently preferred embodiments together with the accompanying drawings in which:

FIG. 1 is a diagram showing a resonance type contactless power transmission system according to a first embodiment;

FIG. 2(a) is a side view, with a part cut away, illustrating the relationship between the shield device and the coils;

FIG. 2(b) is a diagram showing the primary-side resonance coil;

FIG. 3 is a side view, with a part cut away, illustrating a shield device according to a second embodiment;

FIG. 4(a) is a side view, with a part cut away, illustrating the relationship between a shield device of a modified embodiment and coils; and

FIG. 4(b) is a diagram showing the primary coil.

### DETAILED DESCRIPTION OF ILLUSTRATIVE EMBODIMENTS

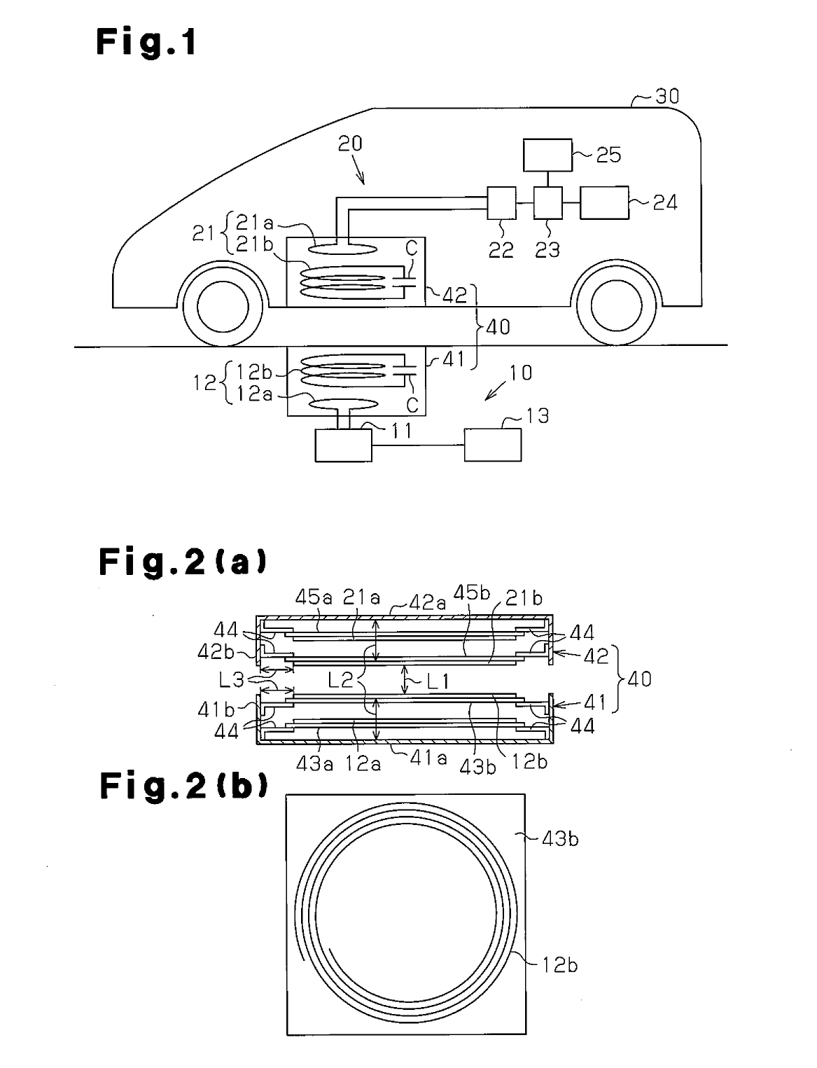

A resonance type non-contact charging system for a vehicle according to a first embodiment of the present disclosure will now be described with reference to FIGS. 1 and 2.

As shown in FIG. 1, a resonance type contactless power transmission system, which is a resonance type non-contact charging system, includes a power supply unit 10 and power receiving unit 20. The power receiving unit 20 is mounted on a vehicle 30, which is a movable body.

The power supply unit 10 includes a high-frequency power source 11, a primary-side coil 12 unit formed by a primary coil 12a and a primary-side resonance coil 12b, and a power source controller 13. The high-frequency power source 11 is controlled based on control signals from the power source controller 13. The high-frequency power source 11 outputs alternating-current power the frequency of which is equal to a predetermined resonant frequency of the resonance system. The frequency of the alternating-current power is, for example, a high-frequency power of several MHz. The primary coil 12a is connected to the high-frequency power source 11. The primary coil 12a and the primary-side resonance coil 12b are arranged such that the coils 12a, 12b are coaxial and that the axes of the coils 12a, 12b extend perpendicular to the ground surface. A capacitor C is connected in parallel to the primary-side resonance coil 12b. The primary coil 12a is coupled to the primary-side resonance coil 12b through electromagnetic induction. The alternating-current power supplied to the primary coil 12a from the high-frequency power source 11 is supplied to the primary-side resonance coil 12b through electromagnetic induction.

The power receiving unit 20 includes a secondary-side coil 21, which is formed by a secondary coil 21a and a secondary-side resonance coil 21b, a rectifier 22, a charger 23, a secondary battery 24 connected to the charger 23, and a vehicle controller 25. The charger 23 includes a booster circuit (not shown) that converts the power from the rectifier 22 to a voltage suitable for charging the secondary battery 24. The vehicle controller 25 controls the booster circuit of the charger 23 when performing charging.

The secondary coil 21a and the secondary-side resonance coil 21b are arranged to be coaxial. A capacitor C is connected in parallel to the secondary-side resonance coil 21b. The secondary coil 21a is coupled to the secondary-side resonance coil 21b through electromagnetic induction. The alternating-current power is supplied from the primary-side resonance coil 12b to the secondary-side resonance coil 21b through resonance. The supplied alternating-current power is then supplied to the secondary coil 21a through electromagnetic induction. The secondary coil 21a is connected to the rectifier 22.

A load is formed by the rectifier 22, the charger 23, and the secondary battery 24. The resonance system is formed by the primary coil 12a, the primary-side resonance coil 12b, the secondary-side resonance coil 21b, the secondary coil 21a, and the load. Although the primary-side resonance coil 12b and the secondary-side resonance coil 21b appear to be helical in FIG. 1, the primary-side resonance coil 12b and the secondary-side resonance coil 21b are spiral in the present embodiment. The primary coil 12a, the primary-side resonance coil 12b, the secondary coil 21a, and the secondary-side resonance coil 21b are made of electric wires, for example, copper wires.

A shield device 40 includes bottom cylindrical shield members 41, 42, which are provided in the power supply unit 10 and the power receiving unit 20, respectively. The shield member 41 provided in the power supply unit 10 has an opening located at the top, and the shield member 42 provided in the power receiving unit 20 has an opening located at the bottom. In the present embodiment, the shield members 41, 42 have the same shape and the same size.

As shown in FIG. 2(a), the primary coil 12a is located on a support plate 43a, which is made of a non-magnetic material. The support plate 43a is fixed to and supported by the inner surface of a cylindrical portion 41b of the shield member 41 via an attaching member 44, which is made of a non-magnetic material. The primary-side resonance coil 12b is located on a support plate 43b, which is made of a non-magnetic material. The support plate 43b is fixed to and supported by the inner surface the cylindrical portion 41b of the shield member 41 via an attaching member 44. The support plate 43b is fixed such that the primary-side resonance coil 12b is located on the opposite side to the bottom 41a of the shield member 41 and that the primary-side resonance coil 12b is located in the vicinity of the opening of the shield member 41. The support plate 43a is fixed such that the primary coil 12a is located on the opposite side to the bottom 41a of the shield member 41 and that the primary coil 12a is located between the support plate 43b and the bottom 41a.

The secondary coil 21a is located on a support plate 45a, which is made of a non-magnetic material. The support plate 45a is fixed to and supported by the inner surface a cylindrical portion 42b of the shield member 41 via an attaching member 44. The secondary-side resonance coil 21b is located on a support plate 45b, which is made of a non-magnetic material. The support plate 45b is fixed to and supported by the inner surface the cylindrical portion 42b of the shield member 41 via an attaching member 44. The support plate 45b is fixed such that the secondary-side resonance coil 21b is located on the opposite side to the bottom 42a of the shield member 42 and that the secondary-side resonance coil 21b is located in the vicinity of the opening of the shield member 41. The support plate 45a is fixed such that the secondary coil 21a is located on the opposite side to the bottom 42a of the shield member 42 and that the secondary coil 21a is located between the support plate 45b and the bottom 42a.

As shown in FIG. 2(b), the support plate 43b is formed to be square, and the primary-side resonance coil 12b is formed to wind in a spiral having constant pitch. In FIG. 2(b), the number of turns of the primary-side resonance coil 12b is four. The pitch and the number of turns of the spiral may be changed as necessary. The support plates 43a, 45a, 45b are formed to have the same configuration as the support plate 43b. The secondary-side resonance coil 21b is formed to have the same configuration as the primary-side resonance coil 12b. The primary coil 12a and the secondary coil 21a is each formed to wind in a spiral. The outer diameter of the coils 12a, 21a is the same as that of the primary-side resonance coil 12b, and the number of turns of the coils 12a, 21a is less than that of the primary-side resonance coil 12b.

As shown in FIG. 2(a), in the shield member 41 provided in the power supply unit 10, the distance between the bottom 41a and the primary-side resonance coil 12b and the distance L3 between the cylindrical portion 41b and the primary-side resonance coil 12b are both set to be greater than the distance L1 between the primary-side resonance coil 12b and the secondary-side resonance coil 21b. In the shield member 42 provided in the power receiving unit 20, the distance L2 between the bottom 42a and the secondary-side resonance coil 21b and the distance L3 between the cylindrical portion 42b and the secondary-side resonance coil 21b are both set to be greater than the distance L1 between the primary-side resonance coil 12b and the secondary-side resonance coil 21b.

Although the distances L2, L3 need to be greater than the distance L1, greater values of the distances L2, L3 increase the spaces for installing the shield members 41, 42. Thus, the distances L2, L3 preferably have values close to the distance L1. For example, the distances L2, L3 are preferably less than or equal to 110% of the distance L1, and more preferably less than or equal to 105% of the distance L1.

Operation of the above described device will now be described.

With the vehicle stopped at a predetermined position near the power supply unit 10, the secondary battery 24, which is mounted on the vehicle, is charged. The power source controller 13 sends a charging request signal to the high-frequency power source 11 to cause the high-frequency power source 11 to output high-frequency power of the resonant frequency of the resonant system to the primary coil 12a. The charging request signal may be output by the vehicle controller 25. Alternatively, the charging request signal may be output when a switch (not shown) of the power supply unit 10 is manipulated.

The high-frequency power source 11 outputs high-frequency power of the resonant frequency of the resonant system to the primary coil 12a, and a magnetic field is generated by electromagnetic induction in the primary coil 12a, which has received the power. The magnetic field is intensified by magnetic field resonance of the primary-side resonance coil 12b and the secondary-side resonance coil 21b. The secondary coil 21a extracts alternating-current power from the intensified magnetic field in the vicinity of the secondary-side resonance coil 21b using electromagnetic induction. After the alternating-current power is rectified by the rectifier 22, the secondary, the charger 23 charges the secondary battery 24 with the rectified power.

The vehicle controller 25 determines the voltage of the secondary battery 24 based on a detection signal of a voltage sensor (not shown), and controls the output voltage of the charger 23 to be a value suitable for charging the secondary battery 24. The vehicle controller 25 determines that the charging is complete (the secondary battery 24 is fully charged) from the length of time that has elapsed since the voltage of the secondary battery 24 becomes the predetermined voltage. When determining that the charging is complete, the vehicle controller 25 sends a charging completion signal to the power source controller 13. Even before the fully charged state is achieved, the vehicle controller 25 stops charging by the charger 23 and sends a charging end signal to the power source controller 13, for example, when the driver inputs a charging stop command. When receiving the charging end signal, the power source controller 13 ends the power transmission (charging).

When power transmission is being carried out through magnetic field resonance, connection of magnetic fields occurs not only between resonance coils (between the primary-side resonance coil 12b and the secondary-side resonance coil 21b), but also, between an induction coil (the primary coil 12a and the secondary coil 21a) and a resonance coil (the primary-side resonance coil 12b and the secondary-side resonance coil 21b) and between the resonance coils 12b, 21b and the shield members 41, 42.

The mutual inductances between the resonance coils, between the induction coil and the resonance coils, and between the resonance coils and the shield members are denoted by M1, M2, and M3, respectively. Leakage induction of the resonance coils is denoted by LE1. In this case, the self-inductance L of the resonance coil is expressed by the following equation:

L=LE1+M1+M2+M3

This equation indicates that the sum of the mutual inductances M1, M2, M3 and the leakage inductance LE1 is constant and that the mutual inductance M1 between the resonance coils can be increased, that is, magnetic field connection between the resonance coils can be reinforced by reducing the mutual inductances M2, M3 between the resonance coil and the shield member. The stronger the magnetic field connection, the higher the power transmission efficiency between the resonance coils becomes. It is expected that, utilizing these properties, the magnetic field connection between the resonance coils will be increased by weakening the magnetic field connection between the resonance coil and the shield member to increase the power transmission efficiency. It was found out that, in this case, the power transmission efficiency when the distance between the resonance coil and the shield member was greater than the distance between the resonance coils was greater than the power transmission efficiency when the distance between the resonance coil and the shield was smaller.

In the present embodiment, the distance L2 between the bottom 41a of the shield member 41 and the primary-side resonance coil 12b is set to be greater than the distance L1 between the resonance coils that allows power transmission at the maximum efficiency from the power supply unit 10 to the power receiving unit 20. The distance L2 between the bottom 42a of the shield member 42 and the secondary-side resonance coil 21b is set to be greater than the distance L1 between the resonance coils that allows power transmission at the maximum efficiency from the power supply unit 10 to the power receiving unit 20. Therefore, in a case where the power transmission is being performed at the maximum efficiency, the magnetic connection between the resonance coils is stronger when the distance L2 is greater than the distance L1 than when the distance L2 is less than or equal to the distance L1. Thus, adverse influence on the power transmission efficiency can be reduced without unnecessarily increasing the space for installing the shield device 40.

The present embodiment has the following advantages.

(1) The shield device 40 includes the shield member 41 provided in the power supply unit 10 and the shield member 42 provided in the power receiving unit 20. The shield members 41, 42 are formed to have a bottom cylindrical shape. The distance L2 between the bottom 41a of the shield member 41 and the primary-side resonance coil 12b and the distance L2 between the bottom 42a of the shield member 42 provided in the power receiving unit 20 and the secondary-side resonance coil 21b are both set to be greater than the distance L1 between the primary-side resonance coil 12b and the secondary-side resonance coil 21b that allows power transmission at the maximum efficiency from the power supply unit 10 to the power receiving unit 20 (L2>L1). When the distance L2 is greater than the distance L1, the magnetic connection between the resonance coils 12b, 21b is stronger than when the distance L2 is less than or equal to the distance L1, and therefore the power transmission efficiency is high. That is, adverse influence on the power transmission efficiency can be reduced without unnecessarily increasing the space for installing the shield device 40.

(2) The distance L3 between the cylindrical portion 41b of the shield member 41 provided in the power supply unit 10 and the primary-side resonance coil 12b and the distance L3 between the cylindrical portion 42b of the shield member 42 provided in the power receiving unit 20 and the secondary-side resonance coil 21b are both greater than the distance L1 (L3>L1). Therefore, the adverse influence on the power transmission efficiency can be reduced.

(3) The power receiving unit 20 is mounted on the vehicle 30. This embodiment minimizes the space for installing the shield device 40, and is favorably applied to a case where the power receiving unit 20 is installed in a vehicle.

(4) The primary-side resonance coil 12b and the secondary-side resonance coil 21b are both formed to be spirals, not helical coils. Therefore, the axial length of the coil 12b, 21b is shorter than that when the primary-side resonance coil 12b and the secondary-side resonance coil 21b are helical. This reduces the space for installing the shield members 41, 42.

(5) The primary-side resonance coil 12b and the secondary-side resonance coil 21b are fixed to the support plates 43b, 45b, respectively, and the support plates 43b, 45b are fixed to and supported by the shield members 41, 42 via the attaching members 44, respectively. Accordingly, the structure for fixing and supporting the primary-side resonance coil 12b and the secondary-side resonance coil 21b to the shield members 41, 42 are simplified.

(6) The primary coil 12a is fixed to the support plate 43a. The primary-side resonance coil 12b is fixed to the support plate 43b. The support plates 43a, 43b are fixed to and supported by the shield member 41 via the attaching members 44. The secondary coil 21a is fixed to the support plate 45a. The secondary-side resonance coil 21b is fixed to the support plate 45b. The support plates 45a, 45a are fixed to and supported by the shield member 42 via the attaching members 44. Therefore, the primary coil 12a and the primary-side resonance coil 12b are easily configured to be coaxial, and the secondary coil 21a and the secondary-side resonance coil 21b are easily configured to be coaxial.

### Second Embodiment

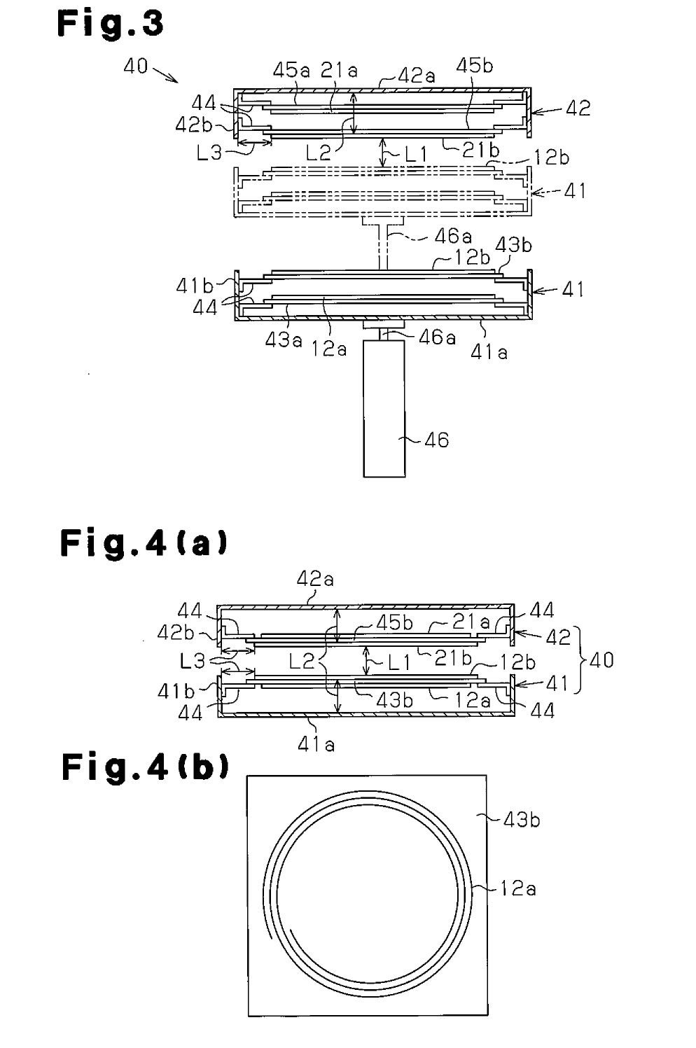

A second embodiment will now be described with reference to FIG. 3. The second embodiment is different from the first embodiment in that the shield member 41 is movable in the axial direction. Like or the same reference numerals are given to those components that are like or the same as the corresponding components of the first embodiment and detailed explanations are omitted.

As shown in FIG. 3, the shield member 41 is fixed at the center of the outer surface of the bottom 41a to a rod 46a of an electric cylinder 46, which is arranged to extend in the vertical direction. When the rod 46a of the electric cylinder 46 is retracted, the shield member 41 is at a standby position, where the shield member 41 is lower than the ground surface on which the vehicle 30 travels. When the rod 46a is protruded, the primary-side resonance coil 12b is at a position where power transmission from the power supply unit 10 to the power receiving unit 20 is performed at maximum efficiency. The power source controller 13 is configured to control the electric cylinder 46.

Other than when transmitting power to the power receiving unit 20, that is, other than when charging the secondary battery 24, the power source controller 13 places the shield member 41 at the standby position. When transmitting power, the power source controller 13 controls the electric cylinder 46 to move the shield member 41 at a position where power transmission from the power supply unit 10 to the power receiving unit 20 is performed at maximum efficiency.

In the present embodiment, when the vehicle 30 is stopped at a predetermined position for charging and the power source controller 13 sends a charging request signal, the electric cylinder 46 is activated to protrude. Accordingly, the shield member 41 is moved from the standby position to the charging position, and the primary-side resonance coil 12b is placed at a position where power transmission from the power supply unit 10 to the power receiving unit 20 is performed at the maximum efficiency. After the charging is complete, the shield member 41 is returned to the standby position.

To perform efficient power transmission from the power supply unit 10 to the power receiving unit 20, the distance between the primary-side resonance coil 12b and the secondary-side resonance coil 21b needs to be reduced (shortened). However, in a case where the power receiving unit 20 is provided (mounted) in the vehicle 30 and the axial direction of the secondary-side resonance coil 21b matches with the up-down direction (the vertical direction), the secondary-side resonance coil 21b needs to be located far apart from the traveling surface (the road surface) to prevent damaging the secondary-side resonance coil 21b due to contact of the coil 21b with an obstacle or the like while the vehicle 30 is moving. In the present embodiment, since the primary-side resonance coil 12b mounted in the power supply unit 10 is movable in the axial direction, the shield member 41 can be located at the standby position except when the secondary battery 24 is charged. The secondary-side resonance coil 21b can be moved away from the road surface by the amount of movement of the primary-side resonance coil 12b. As a result, the secondary-side resonance coil 21b is prevented from being damaged from contact with an obstacle or the like.

The second embodiment has the following advantages in addition to the advantages (1) to (6) of the first embodiment.

(7) The primary coil 12a and the primary-side resonance coil 12b are fixed to and supported by the shield member 41. The secondary coil 21a and the secondary-side resonance coil 21b are fixed to and supported by the shield member 42. The shield member 41, which is provided in the power supply unit 10, is configured to be movable in the axial direction. During power transmission (charging), the shield member 41 is moved such that the distance between the primary-side resonance coil 12b and the secondary-side resonance coil 21b is minimized. Even though the secondary-side resonance coil 21b is located far apart from a road surface to prevent damage of the secondary-side resonance coil 21b of the power receiving unit 20 mounted on the vehicle 30 due to a contact of the secondary-side resonance coil 21b with an obstacle or the like while the vehicle 30 is moving, power transmission during charging can be performed efficiently.

Embodiments are not limited to the above, for example, and may be embodied as follows.

The shield device 40 may have any structure as long as the distance L2 between the bottom 41a of the shield member 41 and the primary-side resonance coil 12b and the distance L2 between the bottom 42a of the shield member 42 and the secondary-side resonance coil 21b are both set to be greater than the distance L1 between the primary-side resonance coil 12b and the secondary-side resonance coil 21b that allows power transmission at the maximum efficiency from the power supply unit 10 to the power receiving unit 20. Therefore, the distance L3 between the primary-side resonance coil 12b and the cylindrical portion 41b and the distance L3 between the secondary-side resonance coil 21b and the cylindrical portion 42b may both be less than or equal to the distance L1. However, the distance L3 is preferably greater than the distance L1.

As shown in FIG. 4(a), the primary coil 12a may be fixed to a surface of the support plate 43b that is opposite to the surface to which the primary-side resonance coil 12b is fixed, and the secondary coil 21a may be fixed to a surface of the support plate 45b that is opposite to the surface to which the secondary-side resonance coil 21b is fixed. In this case, as shown in FIG. 4(b), the outer diameter of the primary coil 12a is smaller than that in the first embodiment. The outer diameter of the secondary coil 21a is also smaller than that in the first embodiment.

The shield member 41 may be configured to be movable so that the distance between the shield member 41 and the primary-side resonance coil 12b is variable. The shield member 42 may be configured to be movable so that the distance between the shield member 42 and the secondary-side resonance coil 21b is variable.

The outer diameter of the primary coil 12a may be formed smaller than the inner diameter of the primary-side resonance coil 12b to dispose the primary coil 12a and the primary-side resonance coil 12b on the same surface of the support plate 43b. The outer diameter of the secondary coil 21a may be formed smaller than the inner diameter of the secondary-side resonance coil 21b to dispose the secondary coil 21a and the secondary-side resonance coil 21b on the same surface of the support plate 45b.

The inner diameter of the primary coil 12a may be formed greater than the outer diameter of the primary-side resonance coil 12b, and the inner diameter of the secondary coil 21a may be formed greater than the outer diameter of the secondary-side resonance coil 21b.

The primary coil 12a, the primary-side resonance coil 12b, the secondary coil 21a, and the secondary-side resonance coil 21b do not need to be formed by spirally winding a wire on a single plane, but may be formed by helically winding a wire as in a coil spring.

The primary coil 12a, the primary-side resonance coil 12b, the secondary coil 21a, and the secondary-side resonance coil 21b may be formed of copper plates or aluminum plates formed into predetermined shapes, instead of wires.

The outer shapes of the primary coil 12a, the primary-side resonance coil 12b, the secondary coil 21a, and the secondary-side resonance coil 21b do not need to be circular, but may be polygonal such as rectangular, hexagonal, or triangular, or may be elliptic. Further, the outer shapes of the primary coil 12a, the primary-side resonance coil 12b, the secondary coil 21a, and the secondary-side resonance coil 21b do not need to be bilaterally symmetrical, but may be asymmetrical.

The support plate 43a, 43b, 45a, 45b may be replaced by support frames to which the primary coil 12a, the primary-side resonance coil 12b, the secondary coil 21a and the secondary-side resonance coil 21b can be fixed. The outer shapes of the support plates 43a, 43b, 45a, 45b and the support frames do not need to be rectangular, but may be any shape such as a circle and octagon, as long as they can support the primary coil 12a and the like.

Instead of using support plates or support frames, the primary coil 12a, the primary-side resonance coil 12b, the secondary coil 21a, and the secondary-side resonance coil 21b may be fixed to and supported by the shield members 41, 42 via the attaching members 44.

Instead of allowing the shield member 41 to be movable in the axial direction, the shield member 42 may be configured to be movable in the axial direction. This configuration also prevents the secondary-side resonance coil 21b from being damaged due to contact with an obstacle or the like while the vehicle 30 is moving. However, each vehicle 30 needs configuration for moving the shield member 42 in this embodiment. Thus, more preferably, the power supply unit 10 may be configured to move the shield member 41.

The shield member 41 and the shield member 42 both may be configured to be movable in the axial direction. This configuration has an advantage in that the amount of movement of each of the shield member 41 and the shield member 42 is smaller than in the case where one of the shield member 41 and the shield member 42 is movable.

When the present disclosure is applied to a resonance type contactless power transmission system for charging a secondary battery 24 mounted in a movable body, the movable body is not limited to the vehicle 30, which requires a driver, but may be an automated guided vehicle or a self-propelled robot.

The resonance type contactless power transmission system may be configured to include an equipment as a movable body to be moved to a working position predetermined by a moving means such as conveyer driven by conventional power without receiving contactless power transmission as a power source, the equipment comprising a motor driven at a constant power as a load and the power receiving unit 20.

The resonance type contactless power transmission system may be configured such that the primary coil 12a, the primary-side resonance coil 12b, the secondary coil 21a, and the secondary-side resonance coil 21b are coaxial, and the coils are located on an axis that extends in the horizontal direction. For example, the axis of the coils of the power receiving unit 20 may extend in a direction perpendicular to the vertical direction of the vehicle 30, and the axis of the coils of the power supply unit 10 may extend in the horizontal direction with respect to the ground surface.

Resonance type non-contact charging system is not limited to the secondary battery 24, for example, may be configured to charge a large capacitor.

The capacitors C connected to the primary-side resonance coil 12b and the secondary-side resonance coil 21b may be omitted. However, a configuration with capacitors C lowers the resonant frequency compared to a configuration without capacitors C. If the resonant frequency is the same, the primary-side resonance coil 12b and the secondary-side resonance coil 21b with capacitors C can be reduced in size compared to a case where the capacitors C are omitted.

What is claimed:

1. A shield device for a resonance type contactless power transmission system, wherein the power transmission system includes:
a power supply unit having a primary-side resonance coil; and
a power receiving unit having a secondary-side resonance coil, the secondary-side resonance coil receives power from the primary-side resonance coil through magnetic field resonance,
the shield device comprising bottom cylindrical shield members, which are provided in the power supply unit and the power receiving unit,
wherein the distance between at least a bottom of the shield member provided in the power supply unit and the primary-side resonance coil and the distance between at least a bottom of the shield member provided in the power receiving unit and the secondary-side resonance coil are both set to be greater than a distance between the primary-side resonance coil and the secondary-side resonance coil that allows power transmission at the maximum efficiency from the power supply unit to the power receiving unit.

2. The shield device for a resonance type contactless power transmission system according to claim 1, wherein the distance between a cylindrical portion of the shield member provided in the power supply unit and the primary-side resonance coil and the distance between a cylindrical portion of the shield member provided in the power receiving unit and the secondary-side resonance coil are both set to be greater than a distance between the primary-side resonance coil and the secondary-side resonance coil that allows power transmission at the maximum efficiency from the power supply unit to the power receiving unit.

3. The shield device for a resonance type contactless power transmission system according to claim 1, wherein the power receiving unit is mounted on a movable body.

4. The shield device according to claim 3, wherein the movable body is a vehicle.

5. The shield device for a resonance type contactless power transmission system according to claim 1, wherein the secondary-side resonance coil and the shield member of the power receiving unit are fixed to the power receiving unit.

6. The shield device for a resonance type contactless power transmission system according to claim 1, wherein the distance between the bottom of the shield member provided in the power supply unit and the primary-side resonance coil and the distance between the bottom of the shield member provided in the power receiving unit and the secondary-side resonance coil are both set to be less than or equal to 110% of a distance between the primary-side resonance coil and the secondary-side resonance coil that allows power transmission at the maximum efficiency from the power supply unit to the power receiving unit.

7. The shield device for a resonance type contactless power transmission system according to claim 1, wherein the power supply system is structured such that the primary-side resonance coil and the shield member are movable in a common axial direction.

8. A resonance type contactless power transmission system comprising:
a power supply unit having a primary-side resonance coil; and
a power receiving unit having a secondary-side resonance coil, the secondary-side resonance coil receives power from the primary-side resonance coil through magnetic field resonance; and
a shield device having bottom cylindrical shield members, which are provided in the power supply unit and the power receiving unit,
wherein the distance between at least a bottom of the shield member provided in the power supply unit and the primary-side resonance coil and the distance between at least a bottom of the shield member provided in the power receiving unit and the secondary-side resonance coil are both set to be greater than a distance between the primary-side resonance coil and the secondary-side resonance coil that allows power transmission at the maximum efficiency from the power supply unit to the power receiving unit.
